(19) United States
(12) Patent Application Publication
(10) Pub. No.: US 2016/0260024 A1
(43) Pub. Date: Sep. 8, 2016

(54) SYSTEM OF DISTRIBUTED PLANNING

(71) Applicant: QUALCOMM Incorporated, San Diego, CA (US)

(72) Inventors: Michael CAMPOS, La Jolla, CA (US); M. Anthony LEWIS, La Jolla, CA (US)

(21) Appl. No.: 14/856,256

(22) Filed: Sep. 16, 2015

Related U.S. Application Data
(60) Provisional application No. 62/128,417, filed on Mar. 4, 2015.

(51) Int. Cl. G06N 99/00

(52) U.S. Cl. CPC G06N 99/005

(57) ABSTRACT

A method for performing a desired sequence of actions includes determining a list of candidate activities based on negotiations with at least one other entity. The determining is also based on preference information, an expected reward, a priority and/or a task list. The list of candidate activities may also be determined based on reinforcement learning. The method also includes receiving a selection of one of the candidate activities. The method further includes performing a sequence of actions corresponding to the selected candidate activity. In this manner, a smartphone or other computing device may be transformed into an intelligent companion for planning activities.

### CROSS-REFERENCE TO RELATED APPLICATION

The present application claims the benefit of U.S. Provisional Patent Application No. 62/128,417, filed on Mar. 4, 2015, and titled “SYSTEM OF DISTRIBUTED PLANNING,” the disclosure of which is expressly incorporated by reference herein in its entirety.

### BACKGROUND

1. Field

Certain aspects of the present disclosure generally relate to machine learning and, more particularly, to systems and methods for performing a desired sequence of actions.

2. Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging. Furthermore, while artificial neural networks have achieved excellent results on variety of classification tasks, they have not yet achieved the more ambitious goals of artificial intelligence. For instance, present day artificial neural networks can recognize a coffee cup with a high degree of accuracy, but present day artificial neural networks cannot arrange for the delivery of a cup of coffee to a person just before he thinks to ask for it.

### SUMMARY

Certain aspects of the present disclosure generally relate to providing, implementing, and using a method of performing a desired sequence of actions. The system may be based on reinforcement learning and may be implemented with a machine learning network, such as a neural network. With this system, a smartphone or other computing device may be transformed into an intelligent companion for planning activities.

Certain aspects of the present disclosure provide a method for performing a desired sequence of actions. The method generally includes determining a list of candidate activities based on negotiations with at least one other entity, and also preference information, an expected reward, a priority and/or a task list. The method may also comprise receiving a selection of one of the candidate activities and performing a sequence of actions corresponding to the selected candidate activity.

Certain aspects of the present disclosure provide an apparatus configured to perform a desired sequence of actions. The apparatus generally includes a memory unit and at least one processor coupled to the memory unit. The processor(s) is configured to determine a list of candidate activities based on negotiations with at least one other entity, and also preference information, an expected reward, a priority and/or a task list. The processor(s) may also be configured to receive a selection of one of the candidate activities and perform a sequence of actions corresponding to the selected candidate activity.

Certain aspects of the present disclosure provide an apparatus for performing a desired sequence of actions. The apparatus generally includes means for determining a list of candidate activities based on negotiations with at least one other entity, and also preference information, an expected reward, a priority and/or a task list. The apparatus may also comprise means for receiving a selection of one of the candidate activities and means for performing a sequence of actions corresponding to the selected candidate activity.

Certain aspects of the present disclosure provide a non-transitory computer readable medium having recorded thereon program code for performing a desired sequence of actions. The program code is executed by a processor and includes program code to determine a list of candidate activities based on negotiations with at least one other entity, and also preference information, an expected reward, a priority and/or a task list. The program code also include program code to receive a selection of one of the candidate activities. The program code further includes program code to perform a sequence of actions corresponding to the selected candidate activity.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a System-on-a-Chip, including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary system for distributed planning in accordance with aspects of the present disclosure.

FIG. 5 illustrates an exemplary to do list, user state information and possible actions in accordance with aspects of the present disclosure.

FIG. 6 illustrates an exemplary set of suggested actions in accordance with aspects of the present disclosure.

FIGS. 7 and 8 are diagrams illustrating a method for distributed planning in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Performing a Desired Sequence of Actions

Smartphones and other mobile devices are becoming agents through which users may interact with the world. By using a smartphone, users can arrange travel, purchase food, find local entertainment, and identify, customize, and request many other services. Unfortunately, coordination of such activities may employ numerous applications, which can be time consuming and result in increased power consumption and user frustration.

Aspects of the present disclosure are directed to user-selected distributed planning for performing a sequence of actions, influenced by reinforcement learning. Selections by a user may initiate a sequence of actions, may accept a proposal that resulted from negotiations with another entity, or may accept a negotiated proposal and initiate a sequence of actions. That is, rather than merely presenting applications, which may include but are not limited to software programs and/or device features that are likely useful, in accordance with aspects of the present disclosure, recommendations for complete activities that may be achieved with user-installed applications may be presented. For example, rather than simply displaying a movie application at night or on weekends, aspects of the present disclosure may further offer to purchase tickets for a suggested movie at a nearby theater at an appropriate time and also arrange for transportation to and from the theater.

Reinforcement learning may be implemented throughout the system for performing a desired sequence of actions. Reinforcement learning is a type of machine learning in which a reward-seeking agent learns through interaction (e.g., trial and error) with an environment. A reward signal is used to formalize the concept of a goal. Behavior in which the desired goal is achieved may be reinforced by providing the reward signal. In this way, the desired behavior may be learned. Reinforcement learning may be implemented in an environment such as a Markov Decision Process (MDP), a partially-observable MDP, a policy search environment or the like. Furthermore, reinforcement learning may be implemented using a temporal-difference learning approach or an actor-critic method, for example, and may be supervised or unsupervised. In this way, the system may further provide suggestions for activities based, for example, on prior user experience and selection.

Reinforcement learning models include variables such as “reward” and “expected reward.” For a system of distributed planning, salient events relating to a smartphone user as he interacts with his smartphone may be mapped to these reinforcement learning variables. For example, after presenting candidate activities to a user, the user may select one of the candidate activities. The system may be configured such that the user's selection of a candidate activity corresponds to a delivery of a “reward.” The effect of the reward would correspond to the effect of a treat given to a pet after the pet exhibits a desired behavior.

For the system to succeed in achieving rewards, it should learn which activities the user is likely to select and when. In terms of reinforcement learning, if a user is likely to select a certain activity in a certain context, the system aims to learn that the activity has a high “expected reward” in that context. To build up “expected reward” knowledge, the system may explicitly query the user to rate a candidate activity as a way of determining an expected reward value for each of the system's suggestions. Alternatively, the system may passively determine expected reward values for each candidate activity by comparing the frequency with which a given suggestion is chosen by the user relative to alternative candidate activities that were simultaneously presented.

An “expected reward” may be further modeled using temporal-difference learning, whereby the system may learn a preferred moment to make a suggestion to the user. Through a model of the user's behavior, the system may learn behavioral patterns exhibited by the user. For example, the system may determine that the user is about to leave work. It may further have learned that he is likely to enter his car a short time later. Based on previous knowledge that the user tends to make phone calls from his car, the system may then predict that the state “leaving work” should be followed by suggestion of the candidate activity “place phone call to X” provided that he first “enters car” and then approximately one minute has elapsed. That is, the system may learn to expect a reward (a selection of a candidate activity) at a certain time after the state “leaving work” is first recognized. The expectation of the reward will grow once the state “enters car” is detected.

While the system may determine with high confidence that the user may wish to place a call at this time, there may still be some uncertainty about the exact time that the user prefers. The system may make two similar suggestions, “place phone call to X now” and “place phone call to X in two minutes.” The user may select the preferred action, thereby indicating the preferred timing, which the system may utilize as a reward signal to further train its model.

Reinforcement learning approaches may further be used to recognize the basic behavioral states of the user, such as “entering car.” Other methods, however, may be used for these aspects. For example, a sensor on a car seat may use near field communication to recognize that the person carrying the smartphone that received a broadcast message has entered the car.

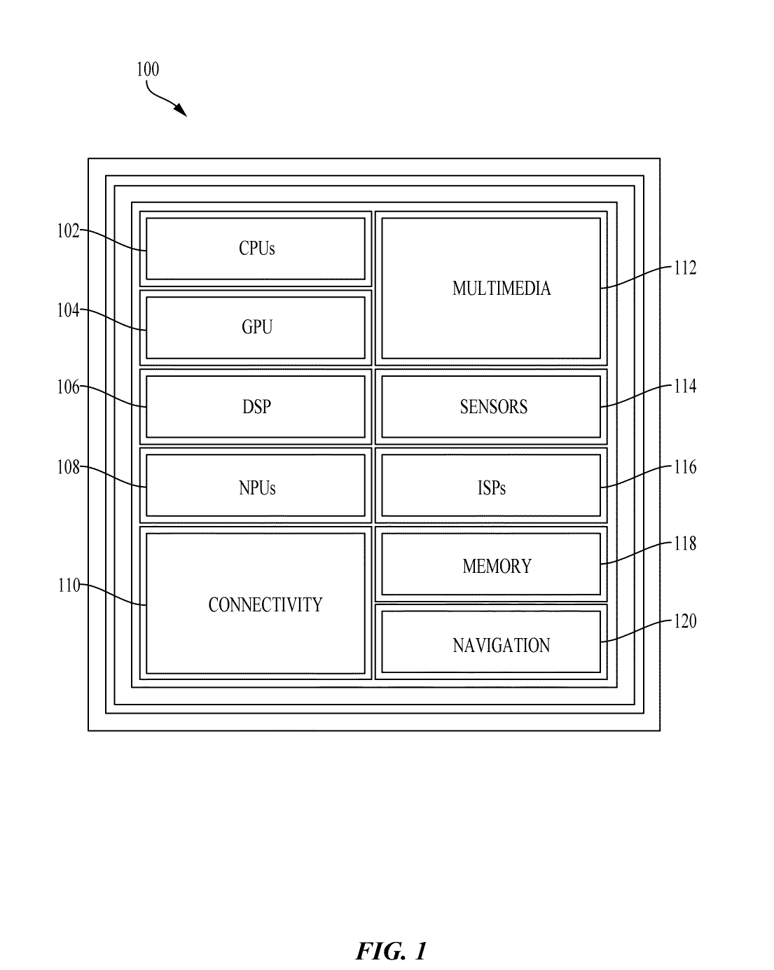

FIG. 1 illustrates an example implementation 100 of the aforementioned distributed planning using a System-on-a-Chip (SOC) 100, which may include a general-purpose processor (CPU) or multi-core general purpose processors (CPUs) 102 in accordance with certain aspects of the present disclosure. Variables (e.g. neural signals and synaptic weights), system parameters associated with a computational device (e.g. neural network with weights), delays, frequency bin information, and task information may be stored in a memory block associated with a Neural Processing Unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system. The SOC may be based on an ARM instruction set.

A possible activity may be an activity that, based on a user's state, including calendar information, could be performed at a specified time. In an aspect of the present disclosure, the instructions loaded into the general-purpose processor 102 may comprise code for determining a list of candidate activities that may include a subset of the possible activities. Furthermore, the candidate activities may be based on negotiations with at least one other entity. The selection of candidate activities may be further based on preference information, an expected reward, a priority and/or a task list.

A negotiation may consist of a communication with at least one other entity, where the other entity may be another person, a machine, a database, an application on a smartphone, or the like. The negotiation may be conducted to determine an action or sequence of actions to be performed by the at least one other entity. The candidate activities may include actions or sequences of actions that accomplish a task on a task list, negotiations with at least one other entity, or a combination of a negotiation and a sequence of actions. An expected reward may be a prediction that a candidate activity will be selected.

A priority may be a ranking associated with items on a task list that are distinct from a user's preference for accomplishing those items on the task list. For instance, a task list item “eat a hot fudge sundae” may have a high preference ranking but a low priority ranking. Likewise, the task item “prepare tax return” may have a low preference ranking but a high priority ranking, especially if it is tax season and the user has not yet submitted a tax return. The instructions loaded into the general-purpose processor 102 may also comprise code for receiving a selection of one of the candidate activities and performing a sequence of actions corresponding to the selected candidate activity.

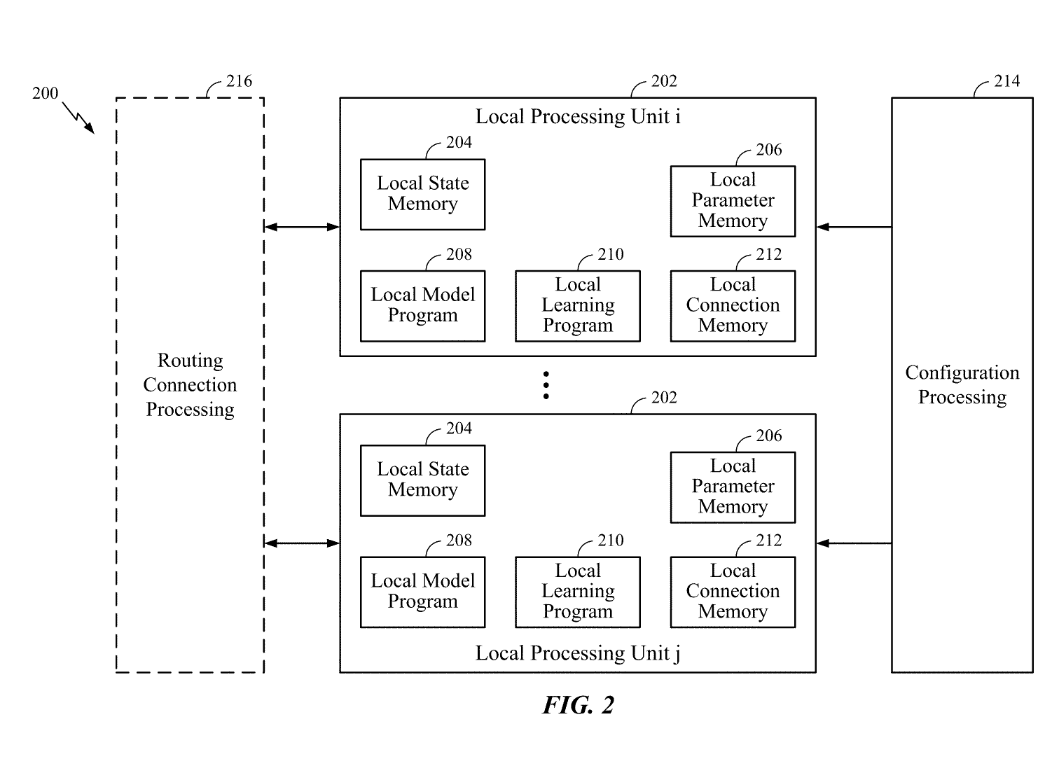

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (e.g., neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high level concept may aid in discriminating the particular low-level features of an input.

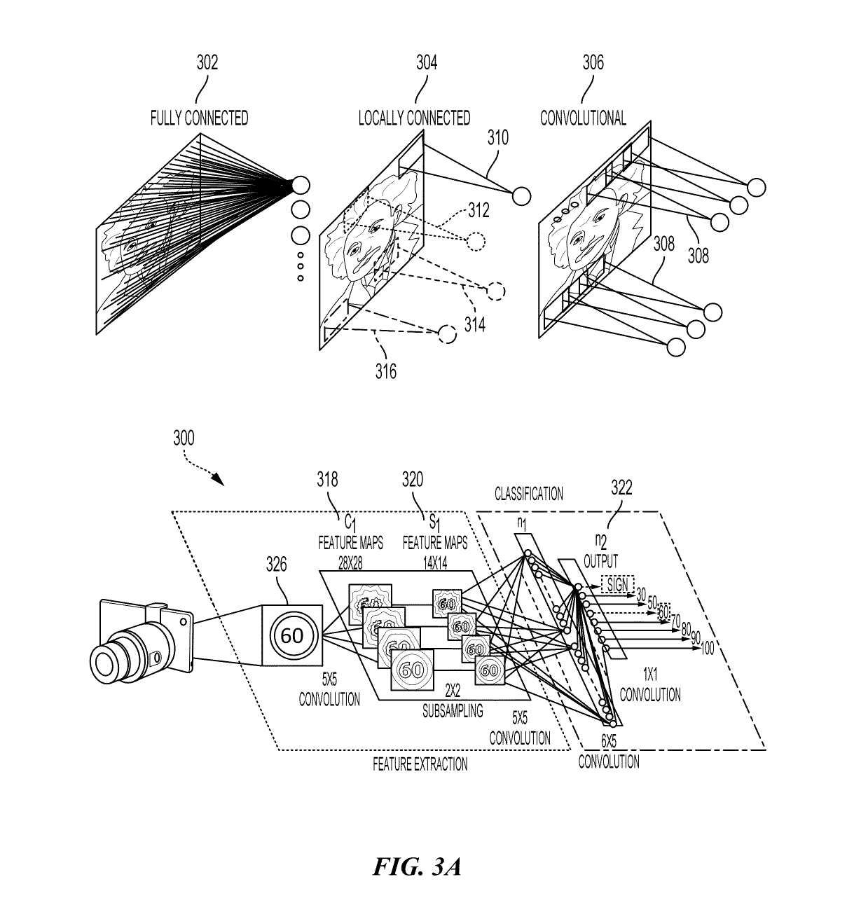

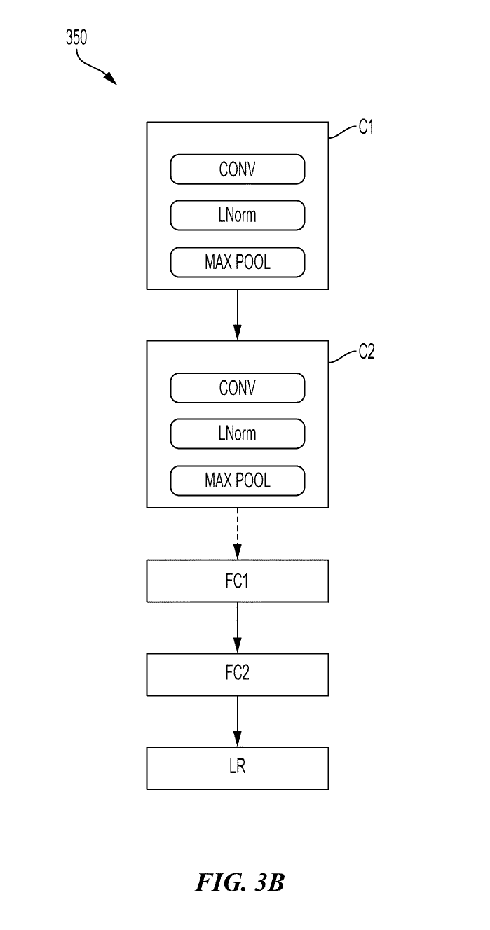

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign, and a “forward pass” may then be computed to produce an output 328. The output 328 may be a vector of values corresponding to features such as “sign,” “60,” and “100.” The network designer may want the DCN to output a high score for some of the neurons in the output feature vector, for example the ones corresponding to “sign” and “60” as shown in the output 328 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 328 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep Convolutional Networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

In one configuration, a computational network is configured for determining a list of candidate activities, receiving a selection of one of the candidate activities, and/or performing a sequence of actions corresponding to the selected candidate activity. The computational network includes a determining means, receiving means and performing means. In one aspect, the determining means, receiving means, and/or performing means may be the general-purpose processor 102, program memory associated with the general purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the network based upon desired one or more functional features of the network, and develop the one or more functional features towards the desired functional features as the determined parameters are further adapted, tuned and updated.

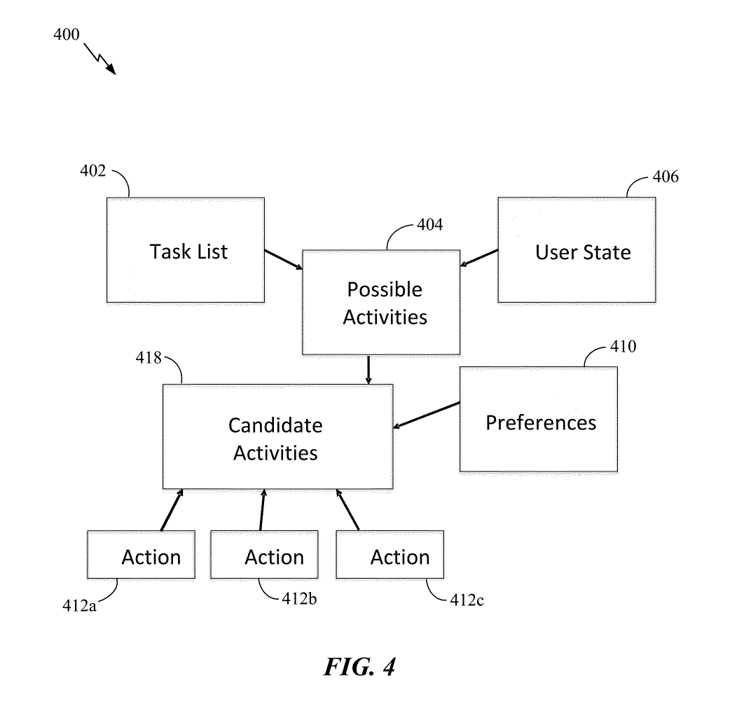

FIG. 4 is a block diagram illustrating an exemplary system 400 for distributed planning in accordance with aspects of the present disclosure. Referring to FIG. 4, the exemplary system 400 may include a to do list block 402, which may also be referred to as a user task list and which may comprise goals, as well as a user schedule of activities to be undertaken by the user or other tasks to be performed by the user. A possible actions block 404 may receive user state information from a user state block 406 and information regarding the user schedule of activities and may generate one or more possible activities.

The user state information may include information regarding the user's status (e.g., location, availability, biometric data) and/or a status of an item controlled by the user. For example, the user state information may indicate that the user has meetings scheduled from 10 am to 4 pm, but is free from 4 pm to 6:30 pm. In another example, the user status may include information indicating that maintenance is due for the user's automobile or that a payment is due for the property taxes on the user's home. The user state information may be provided via user input, sensor data or may be supplied via an external data source.

The possible activities may be supplied to a candidate activities block 418 along with user preference information via a preferences block 410. Although, the present example shows three candidate activities (e.g., associated with action blocks 412a, 412b, and 412c), the disclosure is not so limiting, and more or fewer candidate activities may be supplied. The candidate activities block 418 may, in turn determine a list of one or more user selectable actions or activities based, for example on the possible activities and the preference information. The user interface where the candidate activities are displayed may be referred to as the action selection block. The preference information may be supplied via user input or may be determined based, for example, on prior selected activities. In one example, a user preference may comprise a preference for exercising 2-4 times per week. This user preference may be specified by user input data or may be determined or inferred from a user's calendar appointments, social media status updates, check-in location information, GPS data or the like. In addition, the user preference information may be arranged according to a priority.

In some aspects, the preference information in the preferences block 410 may be initially empty. Thereafter, preferences may be determined based on user selection. When a user selects a particular candidate activity or action, an entry may be made in the preferences block 410 and likelihood of suggestion of that activity or action in the future may increase. On the other hand, when a candidate activity or action is not selected (e.g., unselected) or is ignored, negative reinforcement learning may be applied such that a suggestion of that activity action in the future may be less likely. Likewise, when a candidate activity is not selected, but instead customized, the suggestion of the initial candidate activity may be less likely in the future. On the other hand, the future suggestion of the customized version of the candidate activity may be more likely.

In some aspects, the preferences block 410 may include or may be informed by average data from one or more users or user groups. For example, the preferences block 410 may include a ratings average for restaurants in the area or user ratings for a movie that is playing in local theaters.

The candidate activities block 418 may also receive activities that may be an action or sequence of actions that result from a negotiation with external sources (e.g., 412a, 412b, 412c). For example, the action selection block 418 may receive an action to upload photographs or video data for an event (e.g., school camping trip) to a media sharing or social media site or an action to prepare and send thank you notes following a birthday party. The external sources may comprise other applications or external data sources. For example, the external sources may comprise applications installed on a smartphone or other user device, or application accessible via a network connection.

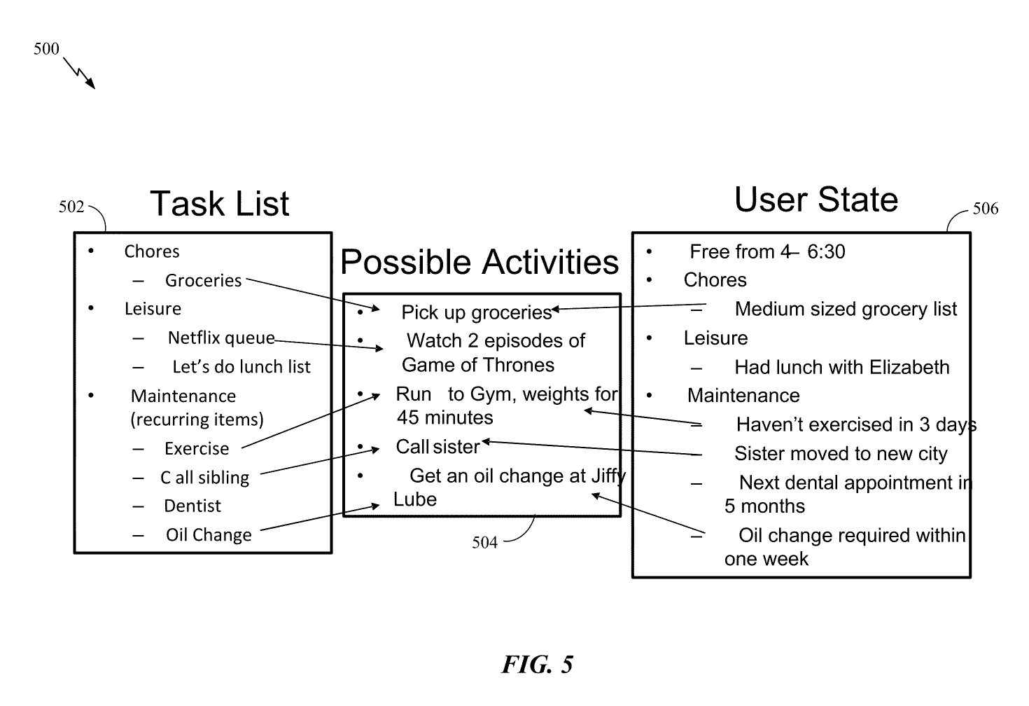

FIG. 5 is a block diagram 500 illustrating an exemplary Task List 502 which may also be referred to as a To-Do List, user state information 506 and possible activities 504 in accordance with aspects of the present disclosure. As shown in FIG. 5, the “to do” or task list 502 may include, for example, chores, leisure activities and maintenance activities. The user state information 506 may include information regarding the user's current status (e.g., location, availability, accomplishments, progress with a particular task, etc.). For example, the user may be having lunch with a friend or the user may have compiled a grocery list. The user state information 506 may also include a timeframe during which the user has not undertaken a particular activity. For instance, the user state information 506 may indicate that it has been 3 days since the user has exercised, or 2 months since the oil has been changed in the user's car.

Using the task list 502 and the user state information 506, one or more possible activities 504 may be determined. For example, a possible activity related to exercising or getting an oil change may be generated.

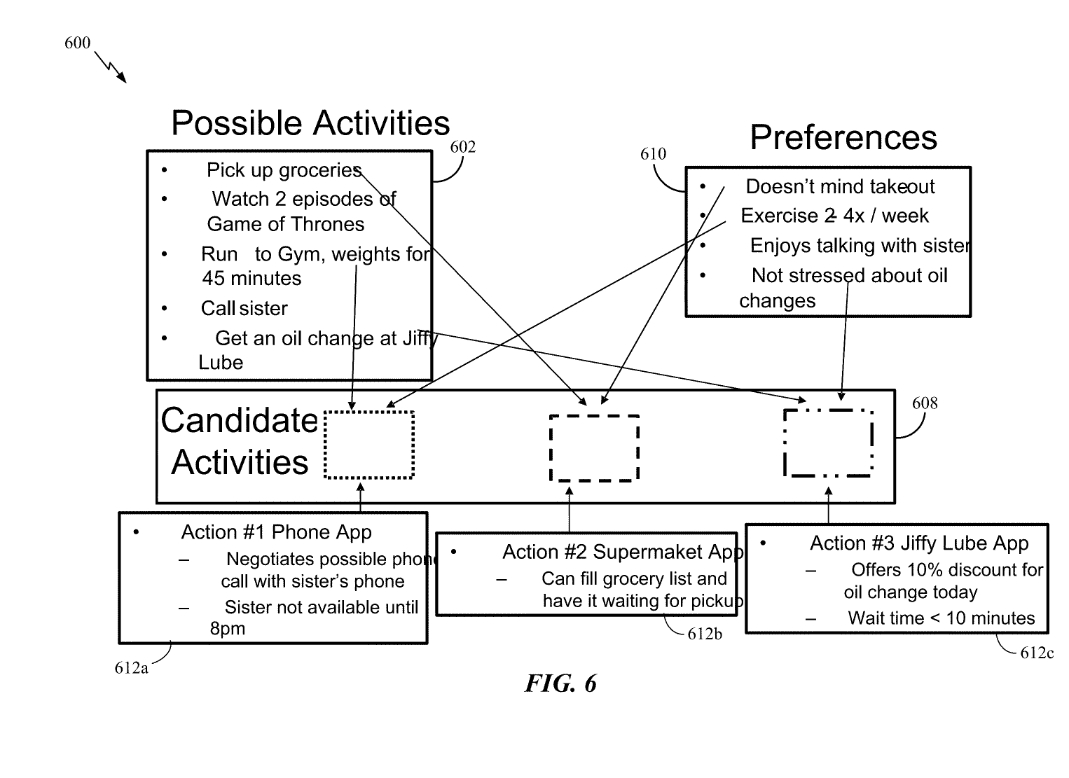

FIG. 6 illustrates an exemplary system 600 for performing a desired sequence of actions in accordance with aspects of the present disclosure. Using the possible actions 602 generated along with the user preferences 610, the candidate activities or action selection block 608 may determine a list of one or more selectable candidate actions or activities (e.g., 612a, 612b and 612c). Although three actions are shown, the number of actions is merely exemplary and not limiting.

The candidate activities may be based on a negotiation with one or more entities. Negotiations may include without limitation, coordination of user schedule and/or preferences and service availability, determination of rates and payment for services. For example, given the possible action of picking up groceries and the user preference information that the user does not mind take out, an action or candidate activity 612b may be negotiated with a supermarket application such that the user's compiled grocery list is filled and arrangements are made via the supermarket application to have the order available for pickup.

In another example, given the possible action for getting an oil change and the user preference information that indicates that oil changes are a relatively low priority for the user, an action or candidate activity 612c may be negotiated using an oil change company application to schedule an oil change if the wait time is less than ten minutes at a nearby oil change center. In either example, the negotiated action or candidate activity may be included in a list of candidate activities and presented to the user for selection.

An action or candidate activity 612a may be a phone call with a sister. In this scenario, a time is negotiated as to when the sister is available. For example, a user's smartphone may coordinate with a calendar of the sister to determine her free time. The action or candidate activity 612a may be presented to the user, indicating the sister's availability for a phone call. Likewise, even if the user has time to make a phone call, the candidate activities block will not display a suggestion to call the user's sister if the sister would be unavailable to take the call.

In some aspects, the negotiated action may be coordinated using multiple applications. For example, in candidate activity 612b, the supermarket application may be used to fill and arrange a pickup time for the user's identified groceries. Additionally, a second application may arrange transportation (e.g., taxi or other car service) to the supermarket to pick up the groceries. Furthermore, a third application, for banking and budgeting may also be used to determine whether non-essential items may be purchased and/or at what price such purchase would meet certain budgetary or cash flow limitations, for example.

The negotiated actions may also coordinate among multiple databases. For example, if a dentist appointment is desired, the negotiated action may include inquiring at the dentist's office for available appointment times and coordinating those times with free time of the user. When a mutually available time is found, a reminder may be set in the user's calendar application.

By selecting a candidate activity or action, the candidate activity may be performed without further action from the user. In this way, the user's smartphone or other computing device may be transformed into an intelligent companion for performing a desired sequence of actions.

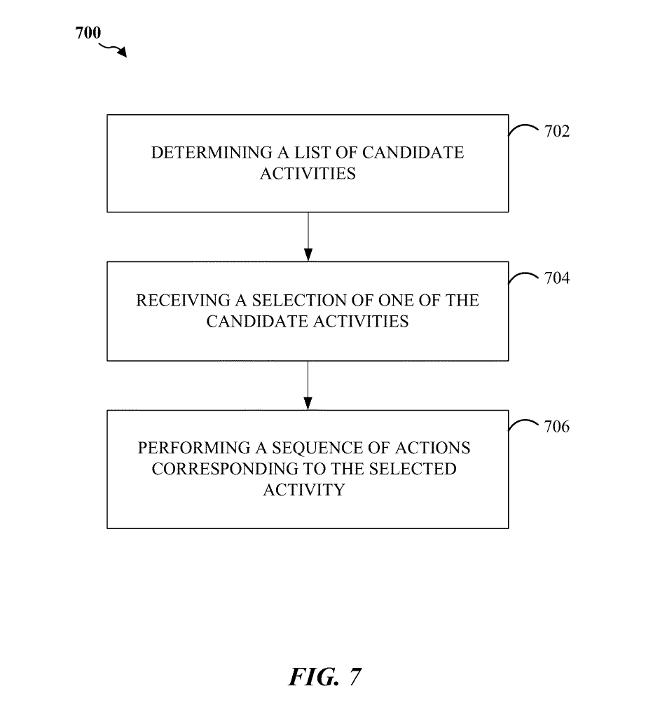

FIG. 7 illustrates a method 700 for distributed planning. In block 702, the process determines a list of candidate activities based on negotiations with one or more entities and one or more of user preferences, an expected reward, a priority or a task list. The one or more entities may comprise a person, business, data center or other entity or service provider.

A negotiation may comprise communication with one or more entities or applications corresponding thereto to determine an action or sequence of actions that may be performed by entities. For example, in negotiating an oil change, the system may query the data center of a national company that specializes in oil change services to algorithmically determine whether the local franchise will offer a reduced price to the user. For a small independent business that offers oil change services, however, there might not be a sophisticated data center to query. In this case, the system may directly query the proprietor of the local business, for example, through the delivery of a text message alerting him that a user requests an offer for a standard oil change at a certain price and at a certain time. The proprietor may approve or decline the request, or make a counter offer, again via text message. In another example, a childcare provider (e.g., babysitter) may enter time-dependent bids for his or her time into a calendar-based application on their phone. For example, weekends during the day could demand a lower tier pricing, while Saturday night could demand a higher pricing. The childcare provider may utilize a computer, smartphone or other mobile device to access an application and may thus be configured to manage bidding automatically for service.

In some aspects, the candidate activities may be determined based on the user's schedule and/or the user state information. In addition, the candidate activities may include categories of actions (e.g., schedule a medical appointment) from a particular schema, known sequences associated with an activity or a sequence of actions learned based on prior action sequence performed by user. The user's state information, may for example include the user current status, availability, location, condition, and the like.

The list of candidate activities may include a subset of the activities presented to the user for selection. An activity may comprise a sequence of actions that may be performed to accomplish a task on the task list, a negotiation with at least one other entity, or combination thereof.

The task list, preference information, and priority may be associated with a user or other entity. The task list may include activities or goals that a user desires to perform. An expected reward is a prediction that a candidate activity will be selected by the user.

In block 704, the process receives a selection of one of the candidate activities. Furthermore, in block 706, the process performs a sequence of actions corresponding to the selected activity. The process may aggregate the sequence across multiple applications and each of the applications may be associated with a different portion of the activity. For example, where the selected activity is a “date night,” applications for calendars for the participants, a car service, a restaurant selection and/or reservation scheduling and a movie and theater location may all be used to coordinate certain aspects of the date.

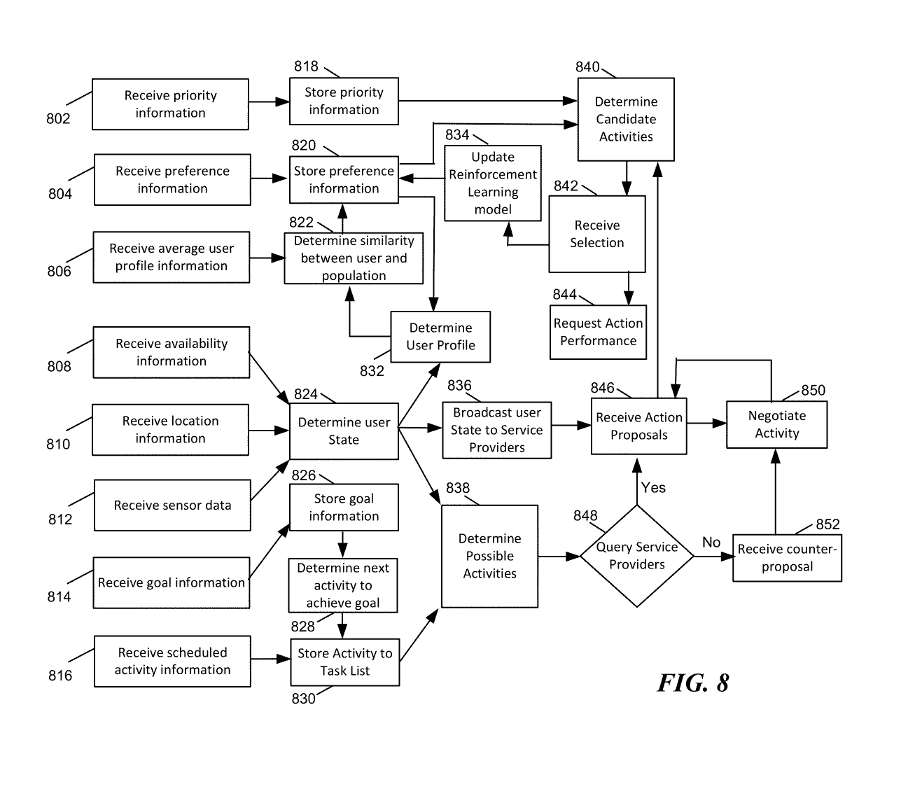

FIG. 8 is a detailed flow diagram illustrating an exemplary method of distributed planning. The process may receive a variety of inputs (e.g. 802-816). In block 802, the process may receive priority information. For example, a user may specify priorities among tasks. In block 818, the priority information may be stored in a memory (e.g., a database of user priorities) for subsequent use. For example, the priority information may be used to determine candidate activities in block 840.

In block 804, the process may receive preference information. For example, the preference information may include a user's preference for one type of activity, a service provider, and the like. In some aspects, the preference information may include a ranking or hierarchy information. In block 820, the preference information may be stored in memory (e.g., a database of user preferences) and may be used to determine candidate activities (block 840). In some aspects, the stored preference information may be updated and/or modified using a reinforcement learning model, which may be updated (block 834) based on a received selection of a candidate activity (block 842). In one exemplary configuration, after the user selects one of the candidate activities (or configures an activity, or ignores a presented activity), the received selection may be used to update a reinforcement learning model. As described above, the reinforcement learning model may attempt to maximize rewards in the form of the user selecting one of the proposed candidate activities. After the reinforcement learning model is updated, the preference information may be modified to more accurately describe the user's actual selection behavior.

The process may also receive availability information (block 808), location information (block 810), and/or sensor data (e.g., biometric data such as from a wearable glucose monitor) (block 812). The availability information, location information and biometric data may be used to determine a user's state (block 824). In some aspects, the determined user state may broadcast to other entities or service providers in block 836. The determined user state may also be used along with preference information to determine a user profile (block 832). The user profile may include demographic information, and may include the user's age, sex, familial information (marital status, number of children, etc.) present location, frequently visited locations, home and work addresses, and the like. For instance, a user profile may include a list of locations that the user tends to visit based on the supplied preference information. Furthermore, the determined user state may be used for determining possible activities (block 838).

In some aspects, the process may also receive average user profile information (block 806). For example, because it may be burdensome for a new user to input preference data, external user profiles may be used to initialize the user preferences based on an average user preference for matching users. For instance, the preference information may be pre-loaded with average data compiled from a user group. In another example, where there is no user-specified profile information, the user profile may be configured, based on the user's location information, to include commonly preferred activities in the user's location without any additional knowledge about the user.

The determined user profile may be compared with the average user profile information to determine similarities between the user and a population (block 822). In one exemplary configuration, a user profile may be compared with a database of other user profiles which themselves contain preference information. Based on a similarity of the user profile and other profiles, the user preferences may be updated to include preferences which are common among other people with similar profiles. These new putative user preferences may be fine-tuned based on the determined candidate activities (block 840), received user selection (block 842), and updating of the reinforcement learning model (block 834).

The process may further receive goal information (block 814) and scheduled activity information (block 816). The goal information may comprise a set of tasks to be accomplished. In some aspects, each task may further include subtasks and sequence information (e.g., a ranking, priority or order in which the task or subtask is to be performed to accomplish the goal). The goal information and the scheduled activity information may be stored (block 826 and 830, respectively). In some aspects, scheduled activities and the activities derived from goals may be compiled into a task list.

The goal information (e.g., tasks) may be used to determine a next activity or activities to be performed to accomplish a goal (block 828). The determined next activity information, the scheduled activity information, and the state information may be used to determine possible activities (block 838). In some aspects, the possible activities may be determined based on the user profile or the preference information.

After the possible activities are determined, service providers may be queried (block 848) in anticipation of the user selecting one of the possible tasks. One or more action proposals may be received from a service provider acknowledging its ability to perform the task on the proposed terms (such as a babysitter's calendar acknowledging availability and acceptance of a usual rate) (block 846). In some aspects, a service provider may acknowledge its ability to perform a task, but may counter-propose (block 852) new terms (such as a higher rate for a car service). In block 850, the process may negotiate with service providers until acceptable terms are reached, or until an acceptable proposal is agreed to by another service provider.

In addition to receiving action proposals based on queries from the system, action proposals may be received from service providers based on a broadcasted user state (block 836). In other words, the process may be conducted even in the absence of task list or goal information.

In block 840, a set of candidate activities may be determined. The candidate activities may be determined based on the set of action proposals, preference information, priority information, or a combination thereof. The candidate activities may be presented to a user. The candidate activities may include the specific actions corresponding to the received action proposals and tasks that were negotiated with a service provider. In block 842, the process may receive a selection from the candidate activities. In turn, in block 844, the process may request that the selected actions be performed. In some aspects, the received selection may include a modification or cancellation of a portion of the selected candidate activities. For example, where the selected candidate activity is a date night, which provides for transportation, dinner reservations and movie tickets at a local theater, a user may modify the date night activity to remove the transportation or to change the movie time.

If the performed action was derived from a user goal, at block 826, the next activity or activities in support of that goal may be determined at block 828 and added to the Task List at block 830.

The candidate activities and/or the listing thereof may be improved by implementing reinforcement learning (block 834). As such, when a user selects a candidate activity, a subsequent suggestion of the selected candidate activity may be more likely. On the other hand, when a candidate activity is not selected or ignored, subsequent suggestion of that candidate activity may be less likely.

In some aspects, the candidate activity may be selected and further customized. For instance, considering the date night example above, where car service is not desired, the car service reservation may be deleted. Such customizations may also be used to improve subsequent suggestions. In some aspects, the candidate activity may include a selection from similar services (e.g., car services, different movie theaters) based on reward, e.g., discount to user provided by service provider; how soon a car could arrive; how close theater is, etc.

In some aspects, the user may receive promotional opportunities from the service providers of the suggested activities. That is, the service providers may be notified of the potential activities and the service providers may provide incentives (reward) that may be included in the listed activities. As such, the service provider incentives may be considered by a user when evaluating the candidate activities presented.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neural networks and other processing systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of performing a desired sequence of actions, comprising:
determining a list of candidate activities based at least in part on negotiations with at least one other entity, and one or more of preference information, an expected reward, a priority and a task list;
receiving a selection of one of the candidate activities; and
performing a sequence of actions corresponding to the selected candidate activity.

2. The method of claim 1, in which the preference information is based at least in part on average data from one or more users.

3. The method of claim 1, in which the selection of a candidate activity increases a likelihood of a subsequent suggestion of the selected candidate activity.

4. The method of claim 1, in which ignoring a candidate activity in the list of candidate activities decreases a likelihood of a subsequent suggestion of the selected candidate activity.

5. The method of claim 1, in which the sequence of actions is aggregated across multiple applications.

6. The method of claim 1, in which the candidate activities comprise categories of actions from a particular schema.

7. The method of claim 1, in which the performing includes selecting from similar services for performing the selected candidate activity based at least in part on the expected reward.

8. An apparatus configured to perform a desired sequence of actions, the apparatus comprising:
a memory unit; and
at least one processor coupled to the memory unit, the at least one processor configured:
to determine a list of candidate activities based at least in part on negotiations with at least one other entity, and one or more of preference information, an expected reward, a priority and a task list;
to receive a selection of one of the candidate activities; and
to perform a sequence of actions corresponding to the selected candidate activity.

9. The apparatus of claim 8, in which the preference information is based at least in part on average data from one or more users.

10. The apparatus of claim 8, in which the at least one processor is further configured to increase a likelihood of subsequent suggestion of the selected candidate activity.

11. The apparatus of claim 8, in which the at least one processor is further configured to decrease a likelihood of subsequent suggestion of an unselected candidate activity in the list of candidate activities.

12. The apparatus of claim 8, in which the at least one processor is further configured to aggregate the sequence of actions across multiple applications.

13. The apparatus of claim 8, in which the candidate activities comprise categories of actions from a particular schema.

14. The apparatus of claim 8, in which the at least one processor is further configured to selecting from similar services for performing the selected candidate activity based at least in part on the expected reward.

15. An apparatus configured to perform a desired sequence of actions, the apparatus comprising:
means for determining a list of candidate activities based at least in part on negotiations with at least one other entity, and one or more of preference information, an expected reward, a priority and a task list;
means for receiving a selection of one of the candidate activities; and
means for performing a sequence of actions corresponding to the selected candidate activity.

16. The apparatus of claim 15, in which the preference information is based at least in part on average data from one or more users.

17. The apparatus of claim 15, in which selection of a candidate activity increases a likelihood of a subsequent suggestion of the selected candidate activity.

18. The apparatus of claim 15, in which ignoring a candidate activity in the list of candidate activities decreases a likelihood of a subsequent suggestion of the selected candidate activity.

19. The apparatus of claim 15, in which the sequence of actions is aggregated across multiple applications.

20. The apparatus of claim 15, in which the candidate activities comprise categories of actions from a particular schema.

21. The apparatus of claim 15, in which the means for performing selects from similar services for performing the selected candidate activity based at least in part on the expected reward.

22. A non-transitory computer-readable medium having recorded thereon program code for performing a desired sequence of actions, the program code being executed by a processor and comprising:
program code to determine a list of candidate activities based at least in part on negotiations with at least one other entity, and one or more of preference information, an expected reward, a priority and a task list;
program code to receive a selection of one of the candidate activities; and
program code to perform a sequence of actions corresponding to the selected candidate activity.

23. The non-transitory computer-readable medium of claim 22, in which the preference information is based at least in part on average data from one or more users.

24. The non-transitory computer-readable medium of claim 22, further comprising program code to increase a likelihood of subsequent suggestion of the selected candidate activity.

25. The non-transitory computer-readable medium of claim 22, further comprising program code to decrease a likelihood of subsequent suggestion of an unselected candidate activity in the list of candidate activities.

26. The non-transitory computer-readable medium of claim 22, in which the sequence of actions is aggregated across multiple applications.

27. The non-transitory computer-readable medium of claim 22, in which the candidate activities comprise categories of actions from a particular schema.

28. The non-transitory computer-readable medium of claim 22, in which the performing includes selecting from similar services for performing the selected candidate activity based at least in part on the expected reward.
